(19) United States
(12) Patent Application Publication
(10) Pub. No.: US 2017/0178045 A1
(43) Pub. Date: Jun. 22, 2017

(54) SOURCE CHANNEL PERFORMANCE METRICS AGGREGATION SYSTEM

(71) Applicant: Hartford Fire Insurance Company, Hartford, CT (US)

(72) Inventors: Ludwig Steven Wasik, West Hartford, CT (US); Andrew Wells Dalton, Simsbury, CT (US); Kimberly A. Rieth, Woodgate, NY (US); Shane Eric Barnes, Avon, CT (US)

(21) Appl. No.: 14/971,253

(22) Filed: Dec. 16, 2015

(51) Int. Cl. G06Q 10/06; G06Q 40/08

(52) U.S. Cl. CPC G06Q 10/06393; G06Q 40/08; G06Q 10/067

(57) ABSTRACT

Methods, methods, apparatus, computer program code and means to evaluate performance via a distributed communication network are provided. In some embodiments, a computer store may contain data for a plurality of source channels, including, for each source channel, historic interaction information. A back-end application server may receive from a remote administrator computer a selected source channel identifier and automatically identify historic interaction information in the computer store associated with the selected source channel identifier. The back-end application server may then evaluate the identified historic interaction information and associated benchmark indications to generate a set of performance metric scores for a selected source channel matching the selected source channel identifier and aggregate the set of performance metric scores to calculate an overall aggregated performance score for the selected source channel. A display may then be rendered on the remote administrator computer including information about the set of performance metric scores and the overall aggregated performance score.

### BACKGROUND

In a computer system, source channels may exhibit different behaviors relative to one another. For example, a first source channel may provide data that is of a higher quality and/or that is more accurate as compared to a second source channel. It can be difficult, however, to evaluate source channel performance, especially when there are a relatively large number of source channels and/or a substantial amount of data that needs to be considered. Note that accurately evaluating source channel performance may let the system adjust one or more source channel parameters (e.g., to improve performance) and/or replace a source channel if necessary.

It would be desirable to provide systems and methods to evaluate source channel performance in a way that provides faster, better results and that allows for flexibility and accuracy in interpreting those results.

### SUMMARY OF THE INVENTION

According to some embodiments, systems, methods, apparatus, computer program code and means for evaluating source channel performance are provided. Some embodiments provide systems, methods, apparatus, computer program code and means to improve data exchange with a remote administrator device. According to some embodiments, a computer store may contain data for a plurality of source channels, including, for each source channel, historic interaction information. A back-end application server may receive from a remote administrator computer a selected source channel identifier and automatically identify historic interaction information in the computer store associated with the selected source channel identifier. The back-end application server may then evaluate the identified historic interaction information and associated benchmark indications to generate a set of performance metric scores for a selected source channel matching the selected source channel identifier and aggregate the set of performance metric scores to calculate an overall aggregated performance score for the selected source channel. A display may then be rendered on the remote administrator computer including information about the set of performance metric scores and the overall aggregated performance score.

Some embodiments comprise: means for collecting data for a plurality of source channels, including, for each source channel, historic interaction information; means for receiving an electronic message requesting a performance evaluation from a remote administrator computer via the distributed communication network, including a selected source channel identifier; means for automatically identifying, by a computer processor of a back-end application computer server, historic interaction information in the computer store associated with the selected source channel identifier; means for evaluating the identified historic interaction information and associated benchmark indications to generate a set of performance metric scores for a selected source channel matching the selected source channel identifier; means for aggregating the set of performance metric scores to calculate an overall aggregated performance score for the selected source channel; and means for rendering a display on the remote administrator computer including information about the set of performance metric scores and the overall aggregated performance score.

In some embodiments, a communication device associated with a back-end application computer server exchanges information with remote devices. The information may be exchanged, for example, via public and/or proprietary communication networks.

A technical effect of some embodiments of the invention is an improved and computerized evaluation of source channel performance in a way that provides faster, better results and that allows for flexibility and accuracy in interpreting those results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is block diagram of a system in accordance with embodiments of the present invention.

FIGS. 4 through 8 illustrate exemplary displays that might be provided according to some embodiments.

FIG. 9 is a block diagram of an apparatus in accordance with some embodiments of the present invention.

FIG. 10 is a portion of a tabular database storing performance metrics results in accordance with some embodiments.

FIG. 11 illustrates a system having a predictive model in accordance with some embodiments.

FIG. 12 illustrates a tablet computer displaying insurance related information according to some embodiments.

### DETAILED DESCRIPTION

The present invention provides significant technical improvements to facilitate dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of source channel performance evaluation by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be transmitted from remote devices to a back-end application server and then analyzed accurately to evaluate source channel performance to improve data that may be created by the system.

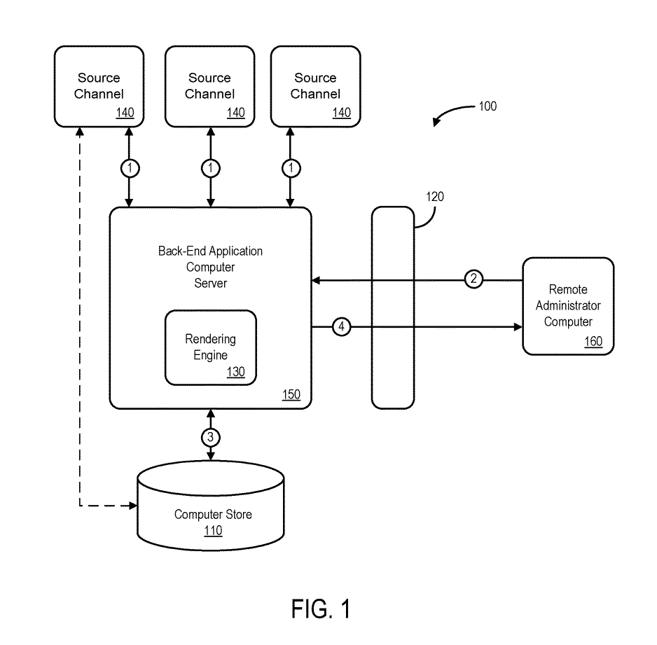

Note that, in a computer system, source channels may exhibit different behaviors relative to one another. For example, a first source channel may provide data that is of a higher quality and/or that is more accurate as compared to a second source channel. It can be difficult, however, to evaluate source channel performance, especially when there are a relatively large number of source channels and/or a substantial amount of data that needs to be considered. Further note that accurately evaluating source channel performance may let the system adjust one or more source channel parameters (e.g., to improve performance) and/or replace a source channel if necessary. It would be desirable to provide systems and methods to evaluate source channel performance in a way that provides faster, better results and that allows for flexibility and accuracy in interpreting those results. FIG. 1 is block diagram of a system 100 according to some embodiments of the present invention. In particular, the system 100 includes a back-end application computer server 150 that may access information in a computer store 110. The back-end application computer server 150 may also exchange information with a remote administrator computer 160 (e.g., via a firewall 120) and/or source channels 140. According to some embodiments, a rendering engine 130 of the back-end application computer server 150 may facilitate the display of information via one or more remote administrator computers 160.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may facilitate the evaluation of source channel 140 performance. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might, for example, store data associated with past and current interactions with source channels 140. The computer store 110 may be locally stored or reside remote from the back-end application computer server 150. As will be described further below, the computer store 110 may be used by the back-end application computer server 150 to generate and/or calculate parameters that will be transmitted to the remote administrator computer 160. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may evaluate performance over a distributed communication network via the automated back-end application computer server 150. For example, at (1) the back-end application computer server 150 may interact with source channels 140 and the computer store 110 may contain data about those interactions 140, including historic result information for each interaction. According to some embodiments, one or more source channels 140 may access the computer store 110 directly (as illustrated by the dashed arrow in FIG. 1).

A communication port may facilitate an exchange of electronic messages with the remote administrator computer 160 via the distributed communication network. The back-end application computer server 150 may receive at (2) from the remote administrator computer 160 a request for a selected source channel 140 performance evaluation (e.g., the request might include an identifier associated with a particular source channel 140). At (3), the back-end application server may access the historic interaction information in the computer store 110, including historic interaction information associated with entities other than the selected source channel 140. The back-end application computer server 150 may render a performance evaluation display at (4) on the remote administrator computer 160 including a set of performance metric scores.

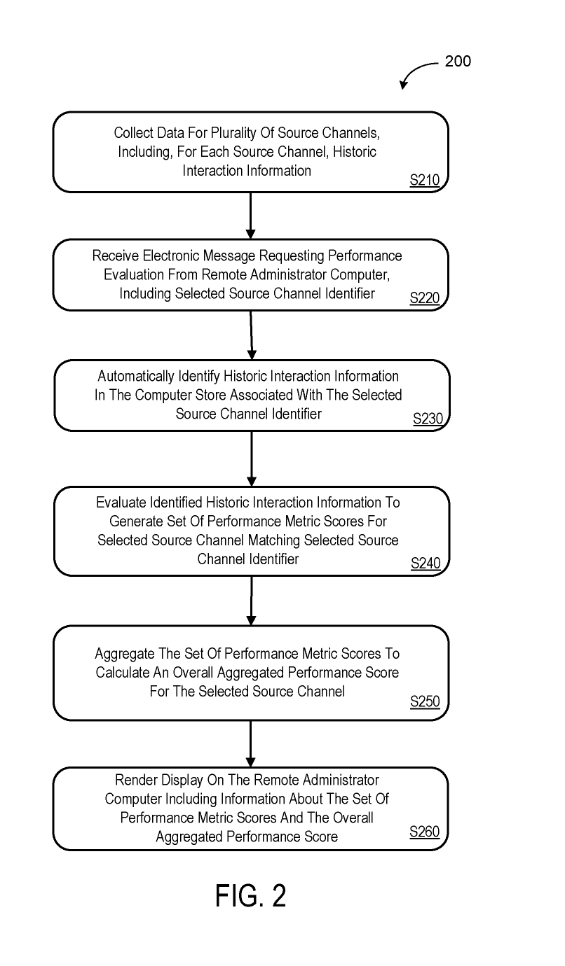

Note that the system 100 of FIG. 1 is provided only as an example, and embodiments may be associated with additional elements or components. According to some embodiments, the elements of the system 100 evaluate performance over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer store may collect data for a plurality of source channels, including, for each source channel, historic interaction information. At S220, a back-end application computer server may receive, from a remote administrator computer, electronic messages requesting performance evaluation for a selected source channel identifier. At S230, the back-end application computer server may automatically identify historic interaction information in the computer store associated with the selected source channel identifier

At S240, the back-end application computer server evaluates the identified historic interaction information to generate a set of performance metric scores for a selected source channel matching the selected source channel identifier. According to some embodiments, the set of performance metric scores for the selected source channel are “benchmarked” in accordance with information defined by the remote administrator computer (e.g., along a line of business, geographic region, etc.) so that different source channels may be compared in an evenhanded and fair fashion. Note that the set of performance metric scores might be associated with source channel behavior, submission quality, and/or submission accuracy. According to some embodiments, the evaluation of the identified historic interaction information to generate the set of performance metric scores for the selected source channel is based at least in part on a predictive model.

At S250, the back-end application computer server aggregates the set of performance metric scores to calculate an overall aggregated performance score for the selected source channel. According to some embodiments, the set of performance metric scores and/or the overall aggregated performance score are input to an automated decision making model (e.g., to make an automated recommendation or decision about a particular source channel). At S260, the back-end application computer server renders a display on the remote administrator computer including information about the set of performance metric scores and the overall aggregated performance score. According to some embodiments, the back-end application computer server further receives from the remote administrator computer a set of filter and aggregation conditions and the rendering is performed in accordance with the set of filter and aggregation conditions (e.g., only interactions meeting a pre-determined criteria might be used to generate the set of performance metric scores). Moreover, according to some embodiments the system may automatically trigger a workflow or make suggestions to an administrator based on the determined performance metric values (e.g., in connection with the top or bottom X % of agencies).

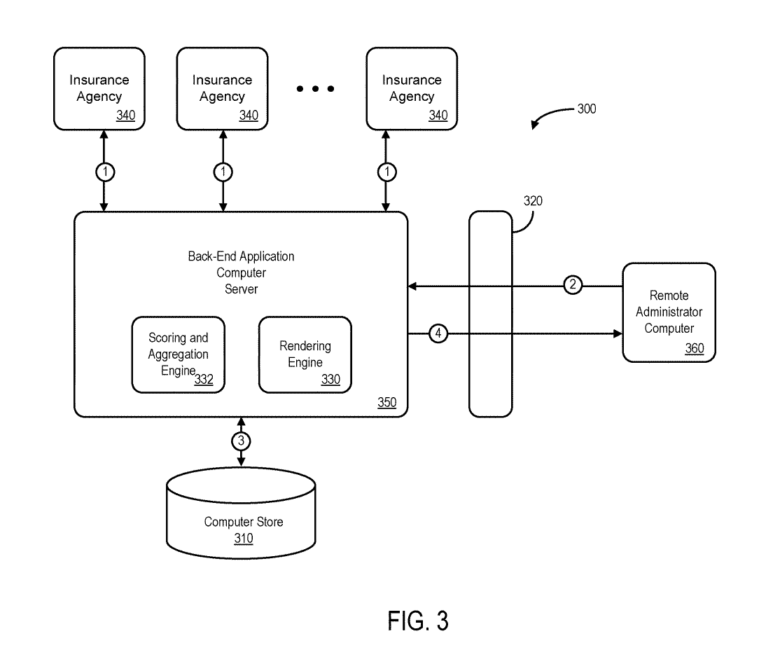

Some of the embodiments described herein may be implemented via an insurance enterprise system. For example, FIG. 3 is block diagram of a system 300 according to some embodiments of the present invention. As in FIG. 1, the system 300 includes a back-end application computer server 350 that may access information in a computer store 310. The back-end application computer server 350 may also exchange information with a remote administrator computer 360 (e.g., via a firewall 320) and/or insurance agencies 340. According to some embodiments, a rendering engine 330 and scoring and aggregation engine 332 of the back-end application computer server 350 facilitates the display of information via one or more remote administrator computers 360.

The back-end application computer server 350 might be, for example, associated with a PC, laptop computer, smartphone, an enterprise server, a server farm, and/or a database or similar storage devices. The back-end application computer server 350 may store information into and/or retrieve information from the computer store 310. The computer store 310 might, for example, store data associated with past and current insurance policy submissions from the insurance agencies 340. The computer store 310 may be locally stored or reside remote from the back-end application computer server 350. As will be described further below, the computer store 310 may be used by the back-end application computer server 350 to generate and/or calculate parameters (e.g., performance metric scores) that will be transmitted to the remote administrator computer 360.

According to some embodiments, the system 300 may evaluate performance over a distributed communication network via the automated back-end application computer server 350. For example, at (1) the back-end application computer server 350 may interact with insurance agencies 340 and the computer store 310 may contain data about those interactions 340, including, for example, whether a particular insurance policy submission received underwriting approval, validation, etc. The back-end application computer server 350 may receive at (2) from the remote administrator computer 360 a request for a selected insurance agency 340 performance evaluation (e.g., the request might include an identifier associated with a particular insurance agency 340). For example, an administrator may use his or her tablet computer to request a performance evaluation report for a particular insurance agency 340. As used herein, the phrase “insurance agency” might refer to, for example, an insurance agent, an insurance agency, an insurance office, a master agency, etc. At (3), the back-end application server may access the historic interaction information in the computer store 310, including historic interaction information associated with entities other than the selected insurance agency 340. The back-end application computer server 350 may render a performance evaluation display at (4) on the remote administrator computer 360 including a set of performance metric scores.

The set of performance metric scores might be associated with, for example: an appetite alignment, a submission quality, a pricing request score, an abused class rate, a parking rate, a new business cancel rate, a bindable refer rate, an unsuccessful quote rate, a customer quality score, a back dating rate, a policy churn rate, and/or a prior claims rate. Moreover, each of the set of performance metric scores might be mapped to a category, such as: favorable, acceptable, watch, investigate, and/or unusual. According to some embodiments, performance metric scores for the selected source channel are benchmarked at: a state level, an industry level, a line of business level, a volume level, and/or a national level.

According to some embodiments, a particular performance metric score is associated with multiple lines of business, including: commercial automobile insurance, business owner's insurance, and/or workers' compensation insurance. Moreover, the particular performance metric score may be, for each of the multiple lines of business, associated with multiple industry divisions. As a result, the particular performance metric score can be, for each of the multiple lines of business and each of the multiple industry divisions, determined based: an underwriting declined value, an underwriting approved value, and/or a validated value. According to some embodiments, the backend application server 350 also calculates, for the selected insurance agency, at least one customer quality score based on: a Standard Industrial Classification (“SIC”) code, prior claims, a credit score, a premium size, a payroll indicator, a multi-line of business flag, and/or a multi-state flag.

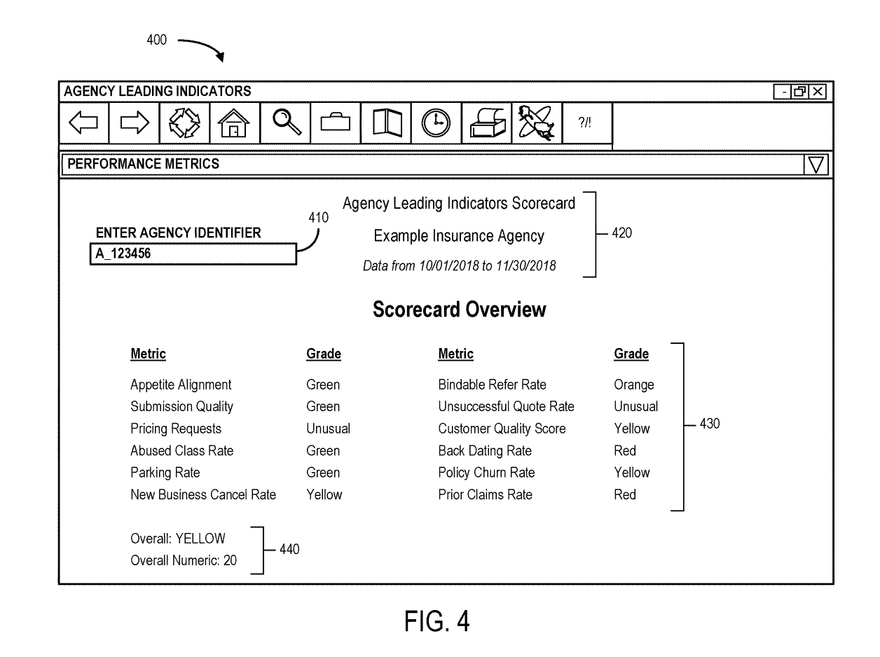

FIGS. 4 through 8 illustrate exemplary displays that might be provided according to some embodiments. In particular, FIG. 4 is an example of scorecard overview display 400 in accordance with some embodiments. The display 400 includes an input area 410 that an administrator can use to select a particular insurance agency (e.g., by entering an identifier, company name, etc.) to be evaluated. Note that the scorecard overview display may include information associated with a particular period of time 420 (e.g., the last twelve months, a time defined by the administrator, etc.).

The display includes a number of performance metric scores 430. The performance metric scores 430 may comprise numeric values or categories. In the example of FIG. 4, “green” is associated with a favorable score, “yellow” is associated with an acceptable score, “orange” is associated with a watch score (e.g., the score should be monitored more closely in the future), “red” is associated with a score that should be investigated, and “unusual” indicates a score that is exceptional (e.g., and might be too good to be true). In addition to the individual performance meter scores 430, the display 400 may include an overall grade and/or overall numeric value 440 (e.g., based at least in part on an aggregation of the performance metric values 430). Note that performance metric scores 430 might be implemented in any way that can convey information to a user. The performance metric scores 430 might be graphical symbols (e.g., a warning indication or flag), a numerical value, a graphical slider, a temperature-based symbol, etc.

Note that a number of different performance metric scores 430 are provided on the display. The “appetite alignment” score might, for example, assume that a low policy submission validation rate and a high declination rate are indicative of poor appetite alignment (and vice versa). The metric may, for example, set benchmarks at the risk state, line of business, and/or industry division levels. By way of example, consider an agency or individual with 15,089 submissions in a particular time period. The actual validation rate was 40.0% as compared to an expectation rate of 33.1%. Moreover, the actual declination rate was 12.1% as compared to an expectation rate of 15.4%. In this case, the agency would probably be classified as having a green appetite alignment.

The “submission quality” score might indicate, for example, that an usually large number of Direct Notices of Cancelation (“DNOC”), Do Not Renew (“DNR”), cancellations for underwriting reasons, etc. are indicative of poor quality submissions from the insurance agency. For example, an insurance agency might have 50 ADM, DTW, DNOC/DNR out of 6,308 ADM issued policies, and 150 policies canceled for other underwriting reasons out of 8,001 total issued policies. This corresponds to an ADM, DTW, DNOC/DNR rate of 0.8% as compared to an expected rate of 1.3% and an “other” underwriting cancel rate of 1.9% as compared to an expected rate of 1.7%. According to some embodiments, details about the canceled policies can be downloaded from a link.

The “pricing requests” score might consider that a high number of pricing requests might be sign that an agency is a price shopper. For example, an agency or individual requested pricing on 3.7% of submissions as compared to an expected rate of 22.6%. As a result the agency might be classified as “unusual.”

The “abused class rate” might consider that a disproportionate use of a vague class codes (e.g., “consultant,” “other professional services,” etc.) may indicative of an agency misrepresenting submissions. For example, an agency or individual might use a commonly abused class on 2.2% of submissions as compared to an expected rate of 5.0% (and therefore be classified as “green”).

The “parking rate” score might consider a high parking rate as being indicative of an agency trying to block a market. For example, an agency or individual with a parking rate of 7488.9% expected rate of 5792.5% might be classified as “red.”

The new business cancel rate score might be used to account for the fact that a high cancel rate (e.g., for underwriting reasons, default, non-payment, policy not taken, etc.) can degrade an insurer's expense ratio. For example, an agency or individual with a new business cancelation rate of 12.3% as compared to an expected rate of 12.2% might be classified as “yellow.”

The “bindable refer rate” score might consider a high bindable refer rate as a sign that an agency or individual might be sending the insurer complex risks. For example, an agency or individual with a bindable refer rate of 5.5% as compared to an expected rate of 4.2% might be classified as “orange.”

The “unsuccessful quote rate” score might consider a high unsuccessful quote rate as a sign that an agency or individual is sending risks in segments where the insurer is less competitive. For example, an agency or individual with an unsuccessful quote rate of 2.6% as compared to an expected rate of 12.4% might be classified as “unusual.”

The customer quality score might be a measure of an insured's future profitability, with a higher score being indicative of higher profitability. According to some embodiments, the scoring under this metric ranges from 4 (best) to 0 (worst).

The “back dating rate” score may be a sign that an agency or individual is retroactively adjusting policy characteristics to artificially lower an insured's premium. For example, an agency or individual with a back dating rate of 35.4% as compared to the small commercial average rate of 14.7% might be classified as “red.”

The “policy churn rate” score may indicate that an agency or individual is producing price sensitive insureds who are likely to quickly leave (which can hurt the expense ratio). According to some embodiments, policy churn is viewed as a composite of an agency's or individual's unsuccessful quote rate, average premium, and non-underwriting cancelation. For example, an agency or individual may have: an unsuccessful quote rate of 2.6% vs. an expected rate of 12.4%; an average written premium per policy of $1190 vs. an expectation of $1292; and a non-underwriting cancel rate of 0.1% as compared to an expected rate of 0.1%. As a result, a “yellow” classification may be assigned.

The “prior claims rate” score may indicate an agency or individual that produces policies with low rates of prior claims is typically viewed positively for sending excellent business to the insurer, while a rate that is too low might be indicative of incomplete reporting. For example, 0.4% of issued policies from an agency or individual might have had prior claims vs. an expected rate of 12.4% (resulting in a score or “red”).

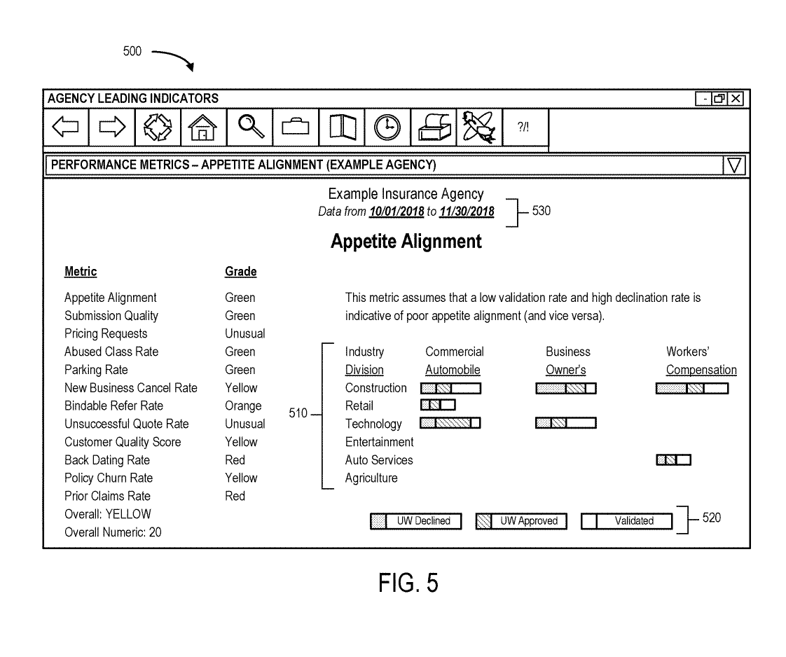

FIG. 5 illustrates a more detailed performance metrics display 500 that might be provided, for example, in connection with the “appetite alignment” performance metric in accordance with some embodiments. The display 500 might comprise, for example, a detailed, customized report on a single insurance agency (the “Example Insurance Agency” in FIG. 5) over a particular period of time. The display 500 may include text and a chart 510 that is dynamically updated based on user input to create a report specific to the insurer agency that has been selected. According to some embodiments, the report may be downloaded and reviewed off-line. Note that the chart 510 includes information about a number of different types of insurance (i.e., commercial automobile, business owner's, and workers' compensation) and a number of different industry divisions (e.g., construction, retail technology, etc.). For each type of insurance and/or industry division, the chart 510 graphically indicates 520 if submissions have received underwriting declination, underwriting approval, or validation as an indication of whether the appetites of the insurer and the insurance agency are in alignment. According to some embodiments, a user may define or adjust a period of time 530 associated with the performance metrics. For example, the user might define the period of time 530 to request performance metrics over the prior month, year, etc. using a pop-up calendar window.

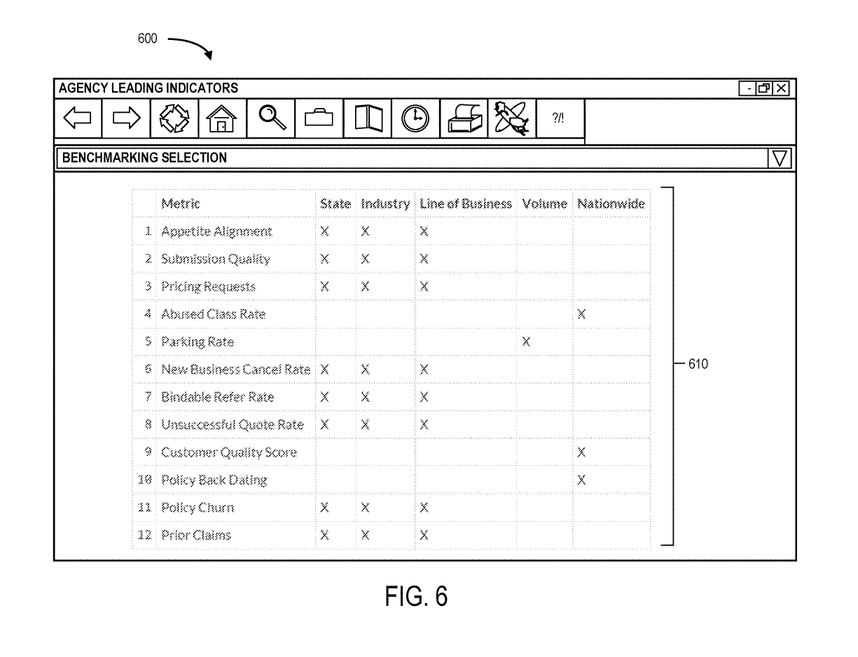

In some cases, it may not be fair to directly compare a first agency's performance with a second agency's performance. For example, the first agency might be located in a first geographic area that is experiencing different conditions as compared to a second geographic area where the second agency is located. To help avoid such a situation, some embodiments described herein may let an administrator define one or more “benchmarking” conditions such that advanced analytics can help ensure that comparisons between various insurance agencies are on a fair basis. For example, FIG. 6 illustrates a benchmarking selection display 600 that might be provided in accordance with some embodiments. In particular, the display 600 includes a benchmarking definition input area 610 where an administrator can, for each of the available performance metrics, define a benchmark parameter as being on a state level (e.g., Connecticut as compared to California), an industry level, a line of business level, a volume level, and/or a nationwide level. The benchmarking selection display 600, for example, help the system compare performance metric scores in a more meaningful manner by letting an administrator tailor the data being compared. As a result, adjustments might be made with respect to the top performing agencies (or bottom performing agencies) as appropriate.

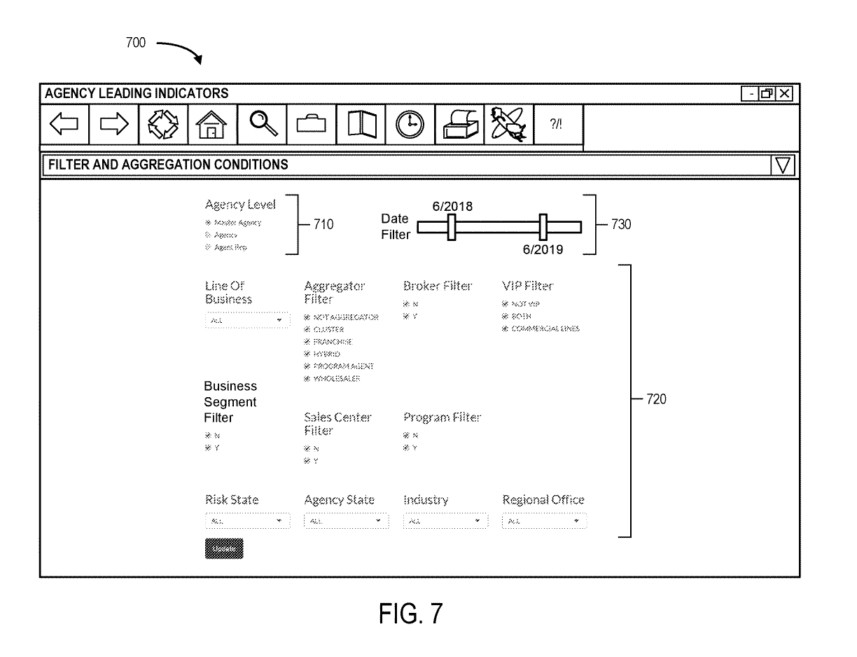

In some cases, an administrator may want to filter and/or aggregate performance metrics results. FIG. 7 is an example of a filter and aggregation selection display 700 according to some embodiments. The display 700 includes an agency level selection area 710 where an administrator can select to have master agency, agency, and/or agent representative level information. The display 700 further includes a definition area 720 where the administrator may select a line of business from a drop-down menu, select aggregation filters (e.g., non-aggregator, cluster, franchise, hybrid, program agent, and/or wholesaler), broker filters, and/or Very Important Person (“VIP”) filters. The definition area 720 of the display 700 may further let the administrator select a business segment filter, a sales center filter, and/or a program filter. Moreover, the definition area 720 may let the administrator select, via drop-down menus, a risk state, an agency state, an industry, and/or a regional office to be associated with an evaluation of performance metric values. Note that any other types of filters and/or parameters might be associated with the display 700. For example, a market segment filter might be provided (e.g., middle market or small commercial). Similarly, according to some embodiments a date filter 730 might be provided wherein a user can define or adjust a period of time (e.g., by moving “begin” date and “end” date graphical sliders) to be used in connection with evaluation of performance metrics. In this way, the system may be used to evaluate performance metrics as of a particular period of time.

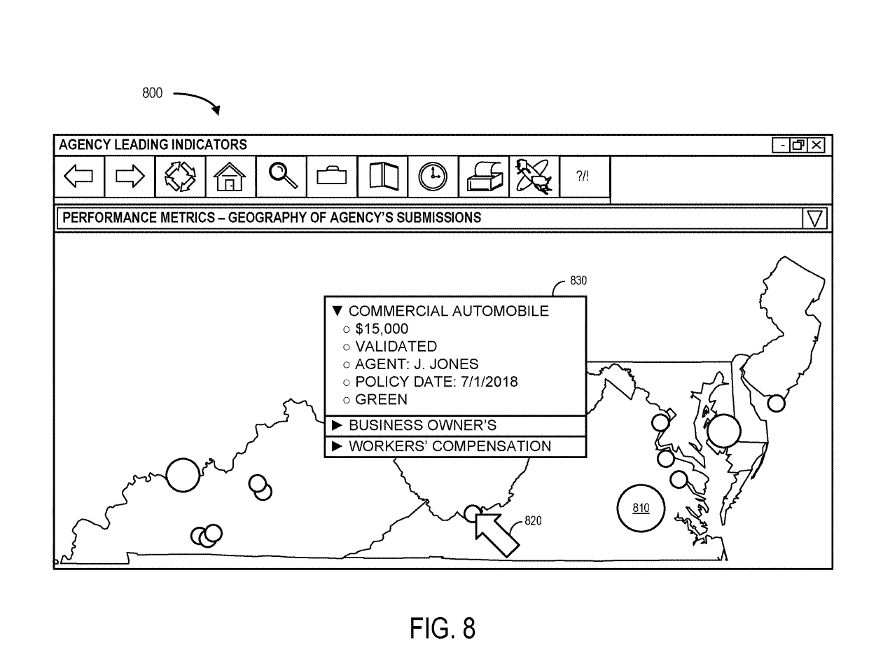

In some cases, an administrator may be interested in geographic information about one or more insurance agencies and/or performance metrics. For example, FIG. 8 illustrates a geographic display 800 of an insurance agency's submissions in accordance with some embodiments. The display 800 includes a map and circular icons 810 for each insurance agency submission. According to some embodiments, a graphical characteristic of each circular icon 810 may vary in accordance with the associated submission. For example, larger circular icons 810 might be associated with higher premiums, red circular icons 810 might be associated with lower quality submissions, etc. According to some embodiments, placing a computer pointer 820 over a circular icon 810 will result in a pop-up window 830 displaying further information about the submission (e.g., commercial automobile details, business owner's details, workers' compensation details, etc.).

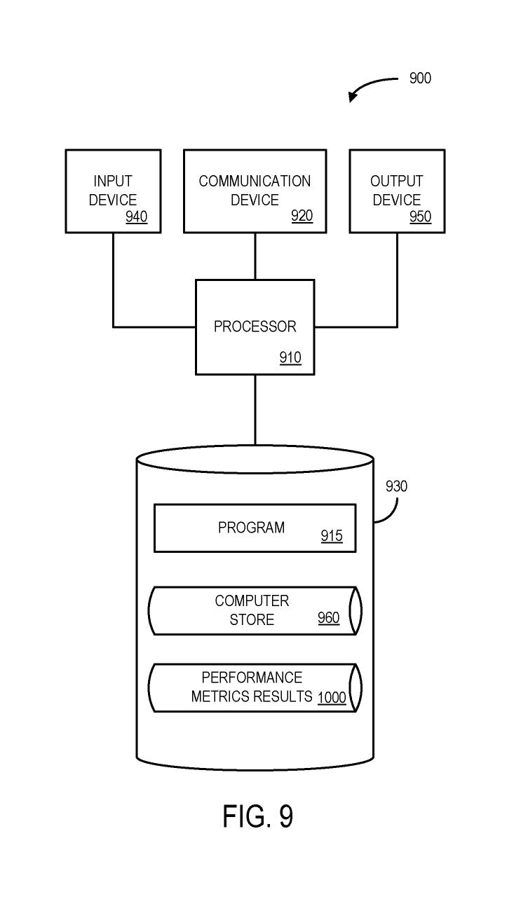

The embodiments described herein may be implemented using any number of different hardware configurations. For example, FIG. 9 illustrates a back-end application computer server 900 that may be, for example, associated with the systems 100, 300 of FIGS. 1 and 3, respectively. The back-end application computer server 900 comprises a processor 910, such as one or more commercially available Central Processing Units (“CPUs”) in the form of one-chip microprocessors, coupled to a communication device 920 configured to communicate via a communication network (not shown in FIG. 9). The communication device 920 may be used to communicate, for example, with one or more remote administrator computers. Note that communications exchanged via the communication device 920 may utilize security features, such as those between a public internet user and an internal network of the insurance enterprise. The security features might be associated with, for example, web servers, firewalls, and/or PCI infrastructure. The back-end application computer server 900 further includes an input device 940 (e.g., a mouse and/or keyboard to enter information about scoring rules or logic, historic information, predictive models, etc.) and an output device 950 (e.g., to output reports regarding system administration, recommendations, and/or insurance agencies).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 915 and/or a coverage advisor tool or application for controlling the processor 910. The processor 910 performs instructions of the program 915, and thereby operates in accordance with any of the embodiments described herein. For example, the processor 910 may receive from a remote administrator computer a selected source channel identifier and automatically identify historic interaction information in the computer store associated with the selected source channel identifier. The processor 910 may then evaluate the identified historic interaction information to generate a set of performance metric scores for a selected source channel matching the selected source channel identifier and aggregate the set of performance metric scores to calculate an overall aggregated performance score for the selected source channel. A display may then be rendered on the remote administrator computer by the processor 910 including information about the set of performance metric scores and the overall aggregated performance score.

The program 915 may be stored in a compressed, uncompiled and/or encrypted format. The program 915 may furthermore include other program elements, such as an operating system, a database management system, and/or device drivers used by the processor 910 to interface with peripheral devices.

As used herein, information may be “received” by or “transmitted” to, for example: (i) the back-end application computer server 900 from another device; or (ii) a software application or module within the back-end application computer server 900 from another software application, module, or any other source.

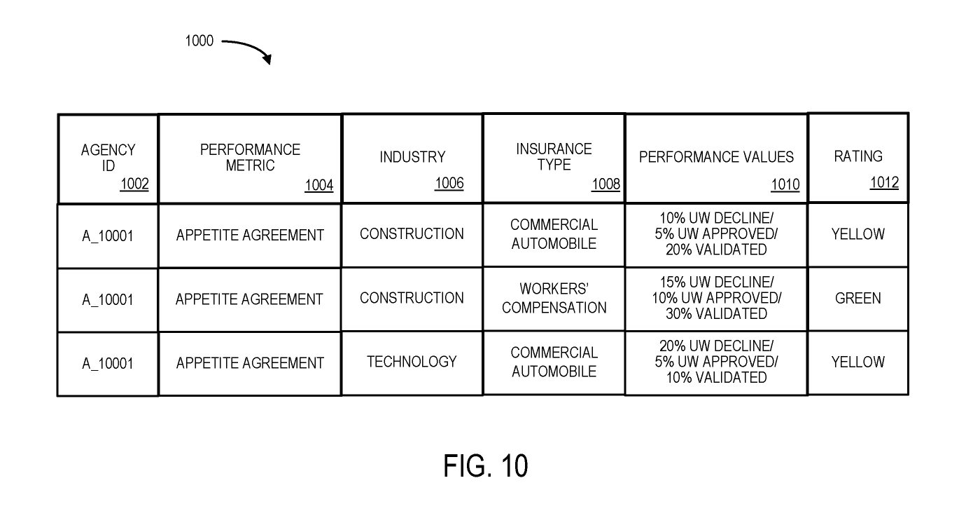

In some embodiments (such as shown in FIG. 9), the storage device 930 further stores a computer store 960 (e.g., associated with past policy submissions, underwriting decisions, premiums, claims, damages, etc.) and a performance metrics results database 1000. An example of a database that might be used in connection with the back-end application computer server 900 will now be described in detail with respect to FIG. 10. Note that the database described herein is only an example, and additional and/or different information may be stored therein. Moreover, various databases might be split or combined in accordance with any of the embodiments described herein. For example, the computer store 960 and/or performance metrics results database 1000 might be combined and/or linked to each other within the program 915.

Referring to FIG. 10, a table is shown that represents the performance metrics results database 1000 that may be stored at the back-end application computer server 900 according to some embodiments. The table may include, for example, entries identifying performance metric values. The table may also define fields 1002, 1004, 1006, 1008, 1010, 1012 for each of the entries. The fields 1002, 1004, 1006, 1008, 1010, 1012 may, according to some embodiments, specify: an agency identifier 1002, a performance metric 1004, an industry 1006, an insurance type 1008, performance values 1010, and a rating 1012. The performance metrics results database 1000 may be created and updated, for example, based on information electrically received from a computer store (e.g., based on prior interactions with an insurance agency or agent).

The agency identifier 1002 may be, for example, a unique alphanumeric code identifying an insurance agency or agent. The performance metric 1004 might indicate a characteristic of the agency being measured (an abused class rate, back dating, policy churn, etc.), the industry 1006 might indicate an area of business being covered (e.g., media, auto services, real estate, etc.), and the insurance type 1008 might specify a type of insurance policy (e.g., workers' compensation, small business, etc.). The performance values 1010 might represent how the insurance agency performed over a period of time (e.g., underwriter approved, underwriter denied, validated, etc.). As a result of that performance, appropriate rating 1012 may be assigned to the insurance agent (e.g., a numerical value, a color, a badge or trophy, etc.).

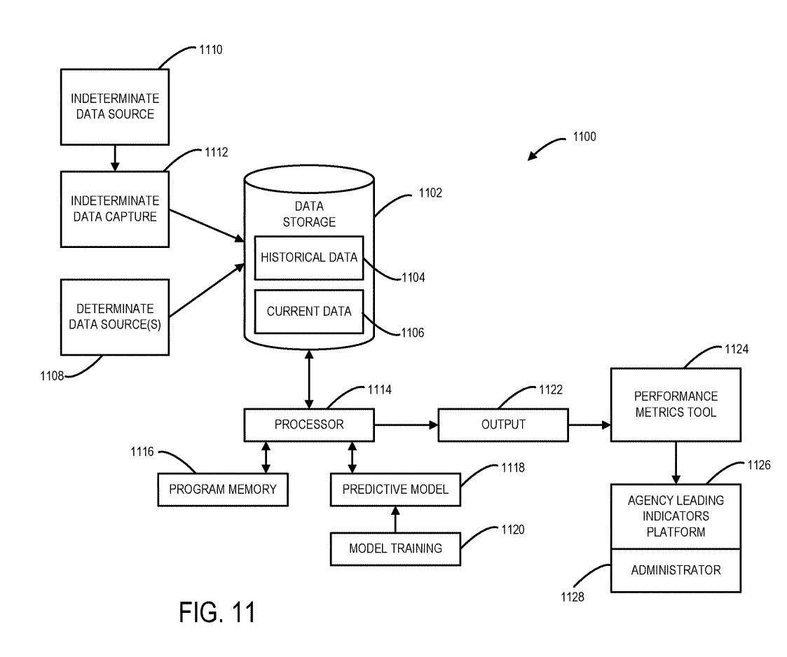

According to some embodiments, one or more predictive models may be used to select and/or score performance metrics. Features of some embodiments associated with a predictive model will now be described by first referring to FIG. 11. FIG. 11 is a partially functional block diagram that illustrates aspects of a computer system 1100 provided in accordance with some embodiments of the invention. For present purposes it will be assumed that the computer system 1100 is operated by an insurance company (not separately shown) for the purpose of supporting automated insurance agency evaluations.

The computer system 1100 includes a data storage module 1102. In terms of its hardware the data storage module 1102 may be conventional, and may be composed, for example, by one or more magnetic hard disk drives. A function performed by the data storage module 1102 in the computer system 1100 is to receive, store and provide access to both historical transaction data (reference numeral 1104) and current transaction data (reference numeral 1106). As described in more detail below, the historical transaction data 1104 is employed to train a predictive model to provide an output that indicates an identified performance metric and/or an algorithm to score a performance metric, and the current transaction data 1106 is thereafter analyzed by the predictive model. Moreover, as time goes by, and results become known from processing current transactions, at least some of the current transactions may be used to perform further training of the predictive model. Consequently, the predictive model may thereby adapt itself to changing conditions.

Either the historical transaction data 1104 or the current transaction data 1106 might include, according to some embodiments, determinate and indeterminate data. As used herein and in the appended claims, “determinate data” refers to verifiable facts such as the an age of a home; an automobile type; a policy date or other date; a driver age; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1108 that are included in the computer system 1100 and are coupled to the data storage module 1102. The determinate data may include “hard” data like a claimant's name, date of birth, social security number, policy number, address, an underwriter decision, etc. One possible source of the determinate data may be the insurance company's policy database (not separately indicated).

The indeterminate data may originate from one or more indeterminate data sources 1110, and may be extracted from raw files or the like by one or more indeterminate data capture modules 1112. Both the indeterminate data source(s) 1110 and the indeterminate data capture module(s) 1112 may be included in the computer system 1100 and coupled directly or indirectly to the data storage module 1102. Examples of the indeterminate data source(s) 1110 may include data storage facilities for document images, for text files, and digitized recorded voice files. Examples of the indeterminate data capture module(s) 1112 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1100 also may include a computer processor 1114. The computer processor 1114 may include one or more conventional microprocessors and may operate to execute programmed instructions to provide functionality as described herein. Among other functions, the computer processor 1114 may store and retrieve historical insurance transaction data 1104 and current transaction data 1106 in and from the data storage module 1102. Thus the computer processor 1114 may be coupled to the data storage module 1102.

The computer system 1100 may further include a program memory 1116 that is coupled to the computer processor 1114. The program memory 1116 may include one or more fixed storage devices, such as one or more hard disk drives, and one or more volatile storage devices, such as RAM devices. The program memory 1116 may be at least partially integrated with the data storage module 1102. The program memory 1116 may store one or more application programs, an operating system, device drivers, etc., all of which may contain program instruction steps for execution by the computer processor 1114.

The computer system 1100 further includes a predictive model component 1118. In certain practical embodiments of the computer system 1100, the predictive model component 1118 may effectively be implemented via the computer processor 1114, one or more application programs stored in the program memory 1116, and computer stored as a result of training operations based on the historical transaction data 1104 (and possibly also data received from a third party). In some embodiments, data arising from model training may be stored in the data storage module 1102, or in a separate computer store (not separately shown). A function of the predictive model component 1118 may be to determine appropriate performance metrics and/or scoring algorithms. The predictive model component may be directly or indirectly coupled to the data storage module 1102.

The predictive model component 1118 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1100 includes a model training component 1120. The model training component 1120 may be coupled to the computer processor 1114 (directly or indirectly) and may have the function of training the predictive model component 1118 based on the historical transaction data 1104 and/or information about potential insureds. (As will be understood from previous discussion, the model training component 1120 may further train the predictive model component 1118 as further relevant data becomes available.) The model training component 1120 may be embodied at least in part by the computer processor 1114 and one or more application programs stored in the program memory 1116. Thus the training of the predictive model component 1118 by the model training component 1120 may occur in accordance with program instructions stored in the program memory 1116 and executed by the computer processor 1114.

In addition, the computer system 1100 may include an output device 1122. The output device 1122 may be coupled to the computer processor 1114. A function of the output device 1122 may be to provide an output that is indicative of (as determined by the trained predictive model component 1118) particular performance metrics and/or evaluation results. The output may be generated by the computer processor 1114 in accordance with program instructions stored in the program memory 1116 and executed by the computer processor 1114. More specifically, the output may be generated by the computer processor 1114 in response to applying the data for the current simulation to the trained predictive model component 1118. The output may, for example, be a numerical estimate and/or likelihood within a predetermined range of numbers. In some embodiments, the output device may be implemented by a suitable program or program module executed by the computer processor 1114 in response to operation of the predictive model component 1118.

Still further, the computer system 1100 may include a performance metrics tool module 1124. The performance metrics tool module 1124 may be implemented in some embodiments by a software module executed by the computer processor 1114. The performance metrics tool module 1124 may have the function of rendering a portion of the display on the output device 1122. Thus, the performance metrics tool module 1124 may be coupled, at least functionally, to the output device 1122. In some embodiments, for example, the performance metrics tool module 1124 may direct workflow by referring, to an administrator 1128 via an agency leading indicators platform 1226, current performance evaluation results generated by the predictive model component 1118 and found to be associated with various insurance agencies. In some embodiments, these recommendations may be provided to an administrator 1128 who may also be tasked with determining whether or not the results may be improved.

Thus, embodiments may provide an automated and efficient way to develop a comprehensive scoring system for evaluating agency partnerships, helping an insurer engage in proactive agency management. Moreover, embodiments may drive proactive discussions concerning agency behaviors that are likely to lead to higher loss ratios. Further, embodiments may help identify agency outliers for possible replacement or improvement. The suite of agency metrics may comprehensively evaluate relationships with each agent, including agency behavior, submission quality, and/or submission accuracy and benchmark models may evaluate an agent against appropriate peers (e.g., in accordance with state, line of business, industry, etc.). According to some embodiments, information is delivered using a web platform that is user friendly, flexible with respect to future development, and scalable and may represent an agency leading indicator tool that is a substantial improvement over the a manual underwriter agency review process (and reviews can be performed by less specialized staff). In addition, agency leading indicators data might be applied to an analytical track (to assist identifying drivers of poor results), a playbook track (to develop a sales communication playbook), an agency/profit management track, and/or a model scoring mart (in connection with an automated decision making model).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

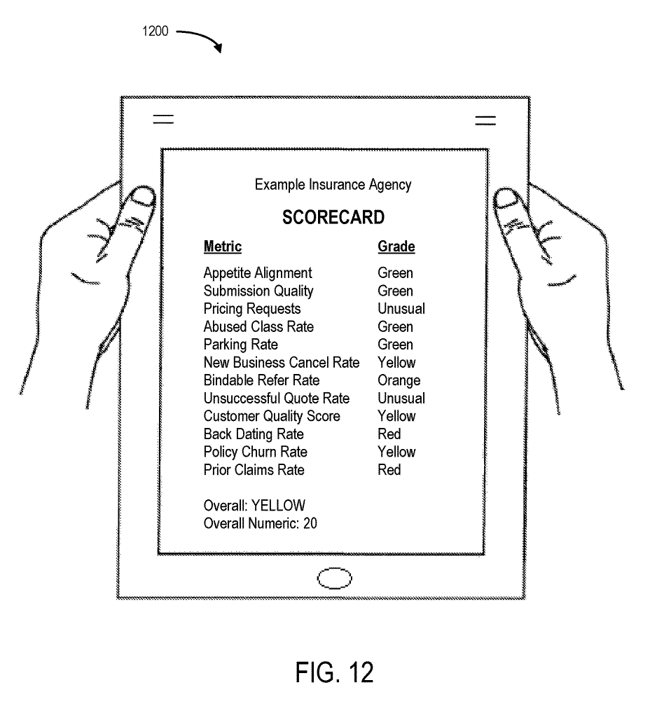

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance. Still further, the displays and devices illustrated herein are only provided as examples, and embodiments may be associated with any other types of user interfaces. For example, FIG. 12 illustrates a handheld insurance agency scorecard display 1200 according to some embodiments.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to evaluate performance over a distributed communication network via an automated back-end application computer server, comprising:
(a) a computer store containing data for a plurality of source channels, including, for each source channel, historic interaction information;
(b) a communication port to facilitate an exchange of electronic messages with a remote administrator computer via the distributed communication network; and
(c) the back-end application computer server, coupled to the computer store and the communication port, and programmed to:
(i) receive from the remote administrator computer a selected source channel identifier,
(ii) automatically identify historic interaction information in the computer store associated with the selected source channel identifier,
(iii) receive from the remote administrator computer a benchmark indication for each of a set of performance metrics,
(iv) evaluate the identified historic interaction information and the benchmark indications to generate a set of performance metric scores for a selected source channel matching the selected source channel identifier,
(v) aggregate the set of performance metric scores to calculate an overall aggregated performance score for the selected source channel, and
(vi) render a display on the remote administrator computer including information about the set of performance metric scores and the overall aggregated performance score.

2. The system of claim 1, wherein a performance metric score for the selected source channel is benchmarked with respect to other source channels when associated with an affirmative benchmark indication.

3. The system of claim 1, wherein the back-end application computer server is further to receive from the remote administrator computer a set of filter and aggregation conditions and the rendering is performed in accordance with the set of filter and aggregation conditions.

4. The system of claim 1, wherein the set of performance metric scores are associated with source channel behavior, submission quality, and submission accuracy.

5. The system of claim 1, wherein the set of performance metric scores are input to an automated decision making model.

6. The system of claim 1, wherein the evaluation of the identified historic interaction information to generate the set of performance metric scores for the selected source channel is based at least in part on a predictive model.

7. The system of claim 1, wherein each source channel comprises an insurance agency and the set of performance metrics includes at least one of: an appetite alignment, a submission quality, a pricing request score, an abused class rate, a parking rate, a new business cancel rate, a bindable refer rate, an unsuccessful quote rate, a customer quality score, a back dating rate, a policy chum rate, and a prior claims rate.

8. The system of claim 7, wherein each of the set of performance metric scores is mapped to a category, including at least one of: favorable, acceptable, watch, investigate, and unusual.

9. The system of claim 7, wherein performance metric scores for the selected source channel are benchmarked at one or more of: a state level, an industry level, a line of business level, a volume level, and a national level.

10. The system of claim 7, wherein a particular performance metric score is associated with multiple lines of business, including at least one of: commercial automobile insurance, business owner's insurance, and workers' compensation insurance.

11. The system of claim 10, wherein the particular performance metric score is, for each of the multiple lines of business, associated with multiple industry divisions.

12. The system of claim 11, wherein the particular performance metric score is, for each of the multiple lines of business and each of the multiple industry divisions, determined based on all of: an underwriting declined value, an underwriting approved value, and a validated value.

13. The system of claim 7, wherein the backend application server is further to calculate, for the selected insurance agency, at least one customer quality score based on at least one of: a standard industrial classification code, prior claims, a credit score, a premium size, a payroll indicator, a multi-line of business flag, and a multi-state flag.

14. A computerized method to evaluate performance over a distributed communication network via an automated back-end application computer server, comprising:
collecting data for a plurality of source channels, including, for each source channel, historic interaction information;
receiving an electronic message requesting a performance evaluation from a remote administrator computer via the distributed communication network, including a selected source channel identifier;
automatically identifying, by a computer processor of a back-end application computer server, historic interaction information in the computer store associated with the selected source channel identifier;
receiving from the remote administrator computer a benchmark indication for each of a set of performance metrics;
evaluating the identified historic interaction information and the benchmark indications to generate a set of performance metric scores for a selected source channel matching the selected source channel identifier;
aggregating the set of performance metric scores to calculate an overall aggregated performance score for the selected source channel; and
rendering a display on the remote administrator computer including information about the set of performance metric scores and the overall aggregated performance score.

15. The method of claim 14, wherein a performance metric score for the selected source channel is benchmarked with respect to other source channels when associated with an affirmative benchmark indication.

16. The method of claim 14, wherein the back-end application computer server is further to receive from the remote administrator computer a set of filter and aggregation conditions and the rendering is performed in accordance with the set of filter and aggregation conditions.

17. The method of claim 14, wherein each source channel comprises an insurance agency and the set of performance metrics includes at least one of: (i) an appetite alignment, (ii) a submission quality, (iii) a pricing request score, (iv) an abused class rate, (v) a parking rate, (vi) a new business cancel rate, (vii) a bindable refer rate, (viii) an unsuccessful quote rate, (ix) a customer quality score, (x) a back dating rate, (xi) a policy chum rate, and (xii) a prior claims rate.

18. The method of claim 17, wherein each of the set of performance metric scores is mapped to a category, including at least one of: (i) favorable, (ii) acceptable, (iii) watch, (iv) investigate, and (v) unusual.

19. The method of claim 17, wherein performance metric scores for the selected source channel are benchmarked at one or more of: (i) a state level, (ii) an industry level, (iii) a line of business level, (iv) a volume level, and (v) a national level.

20. The method of claim 17, wherein a particular performance metric score is associated with multiple lines of business, including at least one of: (i) commercial automobile insurance, (ii) business owner's insurance, and (iii) workers' compensation insurance.

21. The method of claim 20, wherein:
the particular performance metric score is, for each of the multiple lines of business, associated with multiple industry divisions, and
the particular performance metric score is, for each of the multiple lines of business and each of the multiple industry divisions, determined based on all of: (i) an underwriting declined value, (ii) an underwriting approved value, and (iii) a validated value.

22. A system to evaluate performance over a distributed communication network via an automated back-end computer server, comprising:
a) a data store including data for a plurality of source channels, including, for each source channel, historic interaction information; and
b) a computer processor coupled to the data store and programmed, upon receiving from a remote administrator computer a selected source channel identifier and a benchmark indication for each of a set of performance metrics, to automatically evaluate historic interaction information and benchmark indications to generate a set of performance metric scores and an overall aggregated performance score for the selected source channel and to serve a web page to the remote administrator computer with at least one performance metric score for a first subset of entities is graphically displayed proximate to an a performance metric score for a second subset of entities.

23. The system of claim 22, wherein at least one of the first and second subset of entities are associated with: a state level, an industry level, a line of business level, a volume level, a national level, commercial automobile insurance, business owner's insurance, and workers' compensation insurance.

24. The system of claim 22, wherein the processor is further to display at least one performance metric score as a graphic icon geographically positioned as appropriate on a map display.
